(19) United States
(12) Patent Application Publication
(10) Pub. No.: US 2008/0118823 A1
(43) Pub. Date: May 22, 2008

(54) Battery housing structures

(75) Inventors: Chi-Shan Yang, Taoyuan County (TW); Su Ning Chang, Taoyuan County (TW); Hsien Peng Ho, Taoyuan County (TW); Chih Yuen Hsieh, Taoyuan County (TW); Sheng Jung Kuo, Taoyuan County (TW)

Correspondence Address: BIRCH STEWART KOLASCH & BIRCH, PO BOX 747, FALLS CHURCH, VA, 22040-0747, US

(73) Assignee: Dynapack International Technology Corp.

(21) Appl. No.: 11/712,389

(22) Filed: Mar. 1, 2007

(30) Foreign Application Priority Data
Nov. 22, 2006 (TW) 95220572

(51) Int. Cl. H01M 2/10

(52) U.S. Cl. 429/100

(57) ABSTRACT

Housing structures for slim batteries are provided. A housing structure comprises a plastic frame surrounding the battery and two metal plates. The battery is covered by the metal plates from opposite sides thereof, respectively. Each of the metal plates comprises a laminar body and a plurality of anchor-shaped protrusions extending therefrom and joining in the plastic frame. Each of the protrusions comprises a flat front edge and two side edges extending from opposite sides thereof to the laminar body, wherein each of the side edges has a smooth recess. The flat front edge of the anchor-shaped protrusion increases effective area of ultrasonic welding. The recess increases contact surface between the frame and the protrusion, improving ultrasonic or high frequency welding and facilitating robust connection thereof.

### BACKGROUND OF THE INVENTION

1. Field of the Invention

The invention relates in general to slim battery modules and in particular to housing structures for slim batteries.

2. Description of the Related Art

Referring to FIG. 1, a conventional slim battery module includes a plastic frame 1, two metal plates 2, and a battery 3 received therebetween. The plastic frame 1 has a plurality of through holes 11, and correspondingly, each of the metal plates 2 has a plurality of protrusions 21 joined in the through holes 11, such that the plastic frame 1 and the metal plates 2 are fixed.

During ultrasonic welding, as shown in FIG. 2, the plates 2 are pressed toward the plastic frame 1, and ultrasonic waves are applied from the plates 2 through indented portions 211 thereof to the plastic frame 1, wherein sidewalls of the holes 11 are melted and deformed by ultrasonic energy, allowing the protrusions 21 to enter the holes 11 of the plastic frame 1. When the plastic frame 1 hardens, the indented portions 211 of the protrusions 21 are tightly engaged with sidewalls of the holes 11, such that the frame 1 and the plates 2 are firmly connected.

However, the conventional mechanism may not provide a sufficiently robust connection against external forces due to limited connection interface between the protrusions 21 and the holes 11.

### BRIEF SUMMARY OF THE INVENTION

Housing structures for slim batteries are provided. The housing structure comprises a plastic frame surrounding the battery and two metal plates. Each of the metal plates has a plurality of anchor-shaped protrusions engaged with the plastic frame, enhancing connection strength between the plastic frame and the metal plate.

An embodiment of the battery is covered by the metal plates from opposite sides thereof. Each of the metal plates comprises a laminar body and a plurality of anchor-shaped protrusions extending therefrom and engaged with the plastic frame. Each of the protrusions comprises a flat front edge and two side edges extending from opposite sides thereof to the laminar body, wherein each of the side edges has a smooth recess.

The flat front edge of the anchor-shaped protrusion improves the effective area of ultrasonic welding. The recess increases contact surface between the frame and the protrusion, improving ultrasonic or high frequency welding efficiency and providing robust connection thereof.

### BRIEF DESCRIPTION OF THE DRAWINGS

The invention can be more fully understood by reading the subsequent detailed description and examples with references made to the accompanying drawings, wherein:

FIG. 1 is an exploded diagram of a conventional housing structure for a slim battery;

FIG. 2 is a sectional view of the housing structure in FIG. 1;

FIG. 3 is a perspective diagram of a housing structure for a slim battery;

FIG. 4 is an exploded diagram of the housing structure in FIG. 3;

FIG. 5 is a perspective diagram of an embodiment of an anchor-shaped protrusion;

FIG. 6 is a perspective diagram of another embodiment of an anchor-shaped protrusion;

FIG. 7 is a sectional view of the housing structure along VII-VII in FIG. 3; and

FIG. 8 is a sectional view of the housing structure along VIII-VIII in FIG. 3.

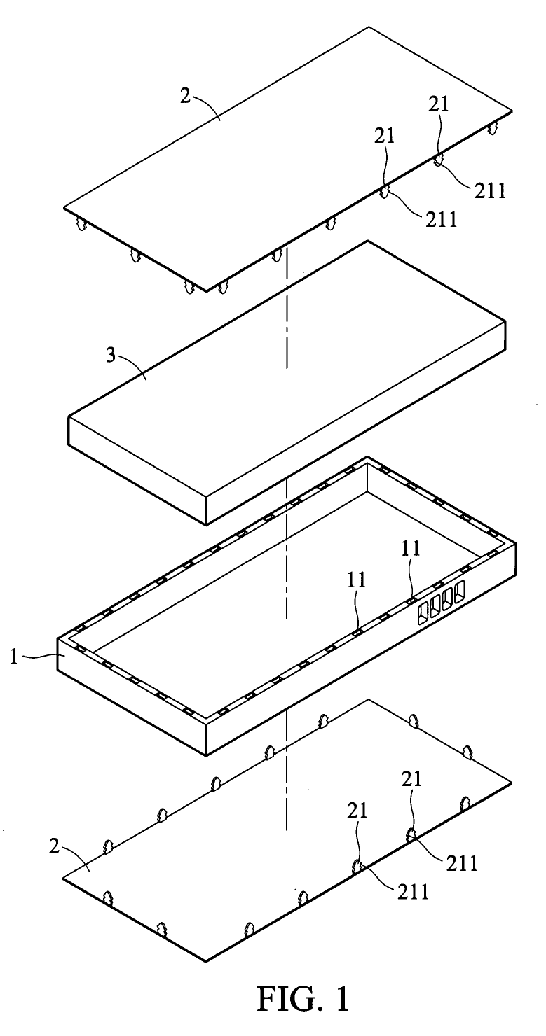

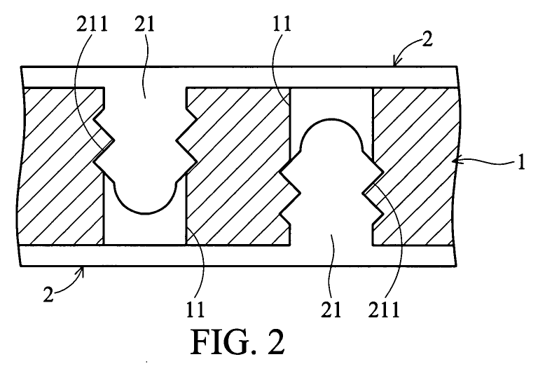

### DETAILED DESCRIPTION OF THE INVENTION

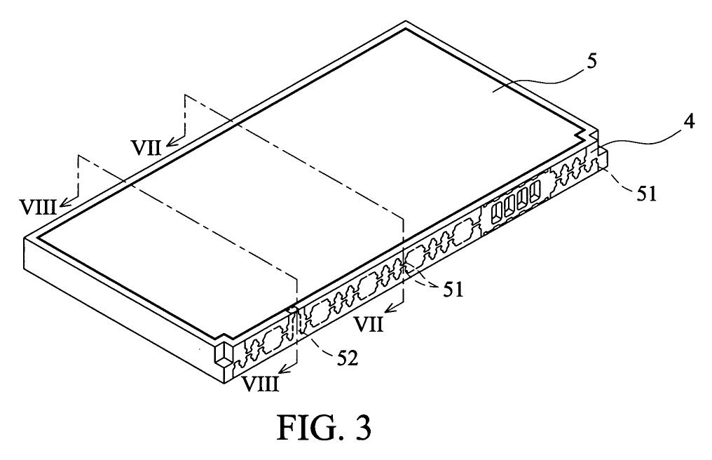

Referring to FIGS. 3 and 4, an embodiment of a housing structure for a slim battery 6 primarily comprises a plastic frame 4 and two metal plates 5. The plastic frame 4 is rectangular and surrounds the battery 6, wherein thickness of the plastic frame 4 approximates that of the battery 6, enabling miniaturization of the battery module. In some embodiments, the battery 6 may include a main body, circuit boards, and protective members (not shown), wherein the main body can be a rechargeable battery, such as polymer, cylindrical or prismatic Li-ion battery including a single or multiple cells.

As shown in FIG. 4, top and bottom surfaces of the battery 6 are covered by the metal plates 5, respectively. Each of the plates 5 has a rectangular laminar body 50, corresponding to the plastic frame 4, and a plurality of protrusions 51 extending from the peripheral of the laminar body 50 into the plastic frame 4.

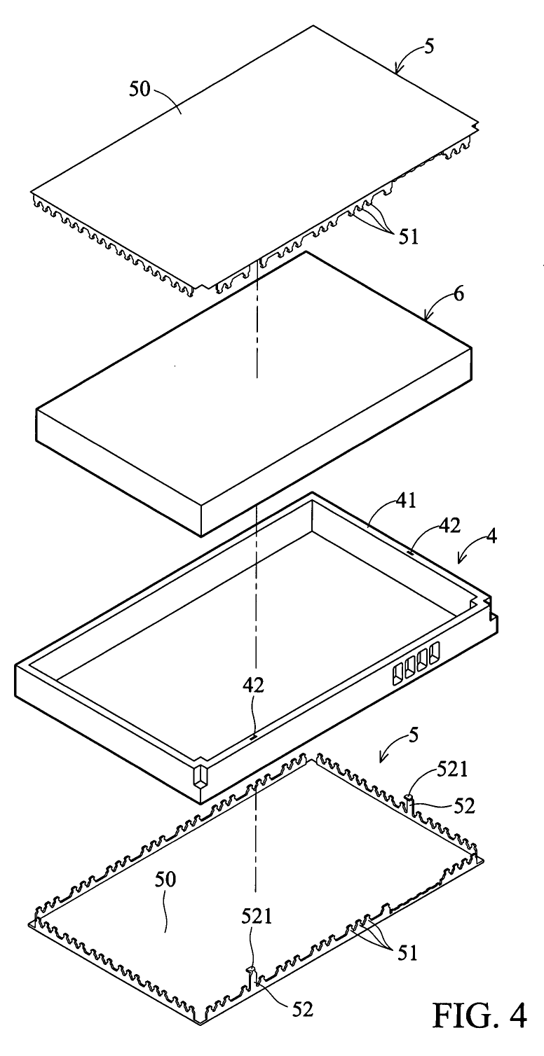

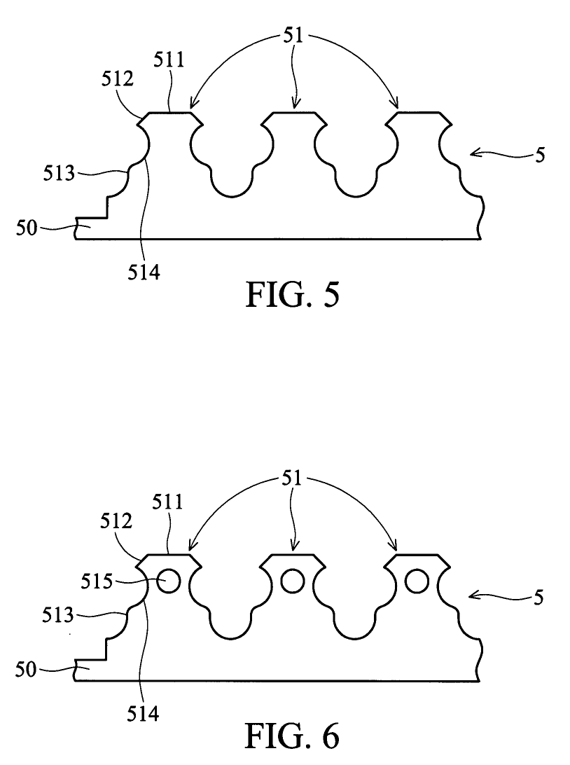

Referring to FIG. 5, the protrusions 51 are anchor-shaped to enhance connection between the frame 4 and the plates 5. Each of the protrusions 51 has a flat front edge 511, two angled edges 512 adjacent to the flat front edge 511, and two side edges 513 connecting the angled edges 512 and the laminar body 50, respectively. As shown in FIG. 5, the flat front edge 511 is substantially parallel to the laminar body 50, and each of the side edges 513 has at least a recess 514. In some embodiments, the side edge 513 may include a single or multiple smooth recesses 514 being curved or polygonal (approximately curved), wherein the recesses 514 on opposite sides of the protrusion 51 can be symmetric or asymmetric.

In this embodiment, the flat front edge 511 can increase effective area and eliminate stress during ultrasonic welding, facilitating even ultrasonic energy transfer to the plastic frame 4. Moreover, the angled edges 512 can improve fluidity of plastic material during ultrasonic welding. The recess 514 can provide a space and large contact surface with plastic engaged therewith, facilitating robust connection between the frame 4 and the protrusion 51. Specifically, smooth surface of the curved recess 514 can improve fluidity of plastic material, preventing gaps between the frame 4 and the protrusion 51 during ultrasonic welding.

In some embodiments, as shown in FIG. 6, each of the protrusions 51 has at least an opening 515 with the plastic material filled therethough, enhancing connection strength between the frame 4 and the plates 5. In some embodiments, the frame 4 and the plates 5 can also be connected by high frequency welding.

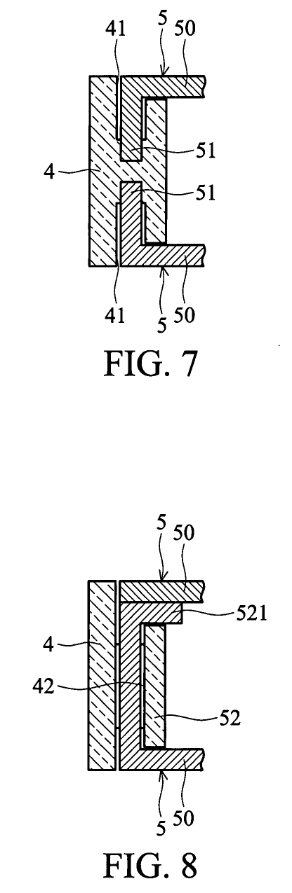

Referring to FIGS. 4 and 7, during assembly, the protrusions 51 of the two plates 5 are inserted in two annular slots 41 of the plastic frame 4 from top and bottom sides, respectively, capable of accurate positioning thereof. As shown in FIGS. 4 and 8, the plastic frame 4 has two through holes 42 with two conductors 52 inserted therethrough for electrical connection of the metal plates 5. Here, each of the conductors 52 projects from a periphery of the bottom plate 5 and has a contact portion 521 physically connecting the top plate 5.

In this embodiment, the two conductors 52 are formed on the bottom plate 5, however, the conductors 52 can also be formed on the top plates 5 or respectively formed on the top and bottom plates 5. In some embodiments, more than two conductors 52 are provided for electrical connection of the two plates 5.

Housing structures for slim batteries are provided according to the embodiments. The flat front edge 511 of the anchor-shaped protrusion 51 can increase effective area of ultrasonic welding. The angled edges 512 can improve fluidity of plastic material during ultrasonic welding. The recess 514 increases contact surface between the frame 4 and the protrusion 51, improving ultrasonic or high frequency welding efficiency and facilitating robust connection thereof.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A housing structure for a slim battery, comprising:
a plastic frame, surrounding the battery; and
two metal plates, connecting the plastic frame and covering the battery from opposite sides thereof, each of the metal plates comprising a laminar body and a plurality of anchor-shaped protrusions extending therefrom and engaged with the plastic frame, each of the protrusions comprising a flat front edge and two side edges extending from opposite sides thereof to the laminar body, wherein each of the side edges has a smooth recess.

2. The housing structure as claimed in claim 1, wherein each of the protrusions further comprises two angled edges between the flat front edge and the side edges, respectively.

3. The housing structure as claimed in claim 1, wherein the recess is curved or polygonal in an approximately curved shape.

4. The housing structure as claimed in claim 1, wherein the plastic frame comprises two annular slots on top and bottom sides thereof with the protrusions received therein for positioning of the plates and the frame.

5. The housing structure as claimed in claim 1, wherein the plastic frame comprises a through hole, and at least one of the plates comprises a conductor projecting from a periphery of the laminar body through the through hole and contacting the other plate.

6. The housing structure as claimed in claim 1, wherein each of the protrusions has an opening therethrough.

7. The housing structure as claimed in claim 1, wherein ultrasonic or high frequency waves are applied to the metal plates, such that the anchor-shaped protrusions are joined in the plastic frame.
